(19) United States
(12) Patent Application Publication
(10) Pub. No.: US 2024/0091644 A1
(43) Pub. Date: Mar. 21, 2024

(54) VIRTUAL OBJECT CONTROL METHOD AND APPARATUS, DEVICE, AND MEDIUM

(71) Applicant: Tencent Technology (Shenzhen) Company Limited, Shenzhen (CN)

(72) Inventors: Jiazhi JIANG, Shenzhen (CN); Siming ZHANG, Shenzhen (CN); Zhen QIAO, Shenzhen (CN)

(21) Appl. No.: 18/516,670

(22) Filed: Nov. 21, 2023

Related U.S. Application Data
(63) Continuation of application No. PCT/CN2022/134686, filed on Nov. 28, 2022.

(30) Foreign Application Priority Data
Feb. 28, 2022 (CN) 202210189724.X

(51) Int. Cl. A63F 13/56; A63F 13/537

(52) U.S. Cl. CPC A63F 13/56; A63F 13/537

(57) ABSTRACT

This application discloses a virtual object control method performed by a computer device. The method includes: displaying a first virtual object and a second virtual object, the first virtual object having a first skill; selecting the second virtual object located within a skill cast range of the first skill based on a preset rule associated with the first virtual object; displaying a skill indicator of the first skill between the first virtual object and the second virtual object; when at least one of the first virtual object and the second virtual object moves, updating the display of the skill indicator; and in response to a skill cast operation, controlling the first virtual object to cast the first skill to the second virtual object.

### CROSS-REFERENCE TO RELATED APPLICATIONS

This application is a continuation application of PCT Patent Application No. PCT/CN2022/134686, entitled “VIRTUAL OBJECT CONTROL METHOD AND APPARATUS, DEVICE, AND MEDIUM” filed on Nov. 28, 2022, which claims priority to Chinese Patent Application No. 202210189724.X, entitled “VIRTUAL OBJECT CONTROL METHOD AND APPARATUS, DEVICE, AND MEDIUM”, and filed on Feb. 28, 2022, all of which is incorporated herein by reference in its entirety.

### FIELD OF THE TECHNOLOGY

This application relates to the field of virtual worlds, and in particular, to a virtual object control method and apparatus, a device, and a medium.

### BACKGROUND OF THE DISCLOSURE

In an online game with a virtual environment, such as a multiplayer online role-playing game, a player can play one or more virtual objects and control an activity and a behavior of the virtual object in a virtual world of the game.

In the online game, the player controls a first virtual object to cast a skill to reduce an attribute value of another virtual object. For example, when the player triggers a skill control, a second virtual object that is closest to the first virtual object or has a lowest attribute value is usually selected as a target for casting the skill.

However, the second virtual object determined based on a distance or a size of the attribute value may not be the target that the player wishes to cast the skill, resulting in lower accuracy of skill cast.

### SUMMARY

Embodiments of this application provide a virtual object control method and apparatus, a device, and a medium, and the technical solutions are as follows.

According to an aspect of this application, a virtual object control method is performed by a computer device, the method including:
displaying a first virtual object and a second virtual object, the first virtual object having a first skill;
selecting the second virtual object located within a skill cast range of the first skill based on a preset rule associated with the first virtual object;
displaying a skill indicator of the first skill between the first virtual object and the second virtual object;
when at least one of the first virtual object and the second virtual object moves, updating the display of the skill indicator; and
in response to a skill cast operation, controlling the first virtual object to cast the first skill to the second virtual object.

According to an aspect of this application, a computer device is provided, the computer device including a processor and memory that stores a plurality of instructions. The plurality of instructions, when executed by the processor, cause the computer device to perform the foregoing virtual object control method.

According to an aspect of this application, a non-transitory computer-readable storage medium is provided, storing a plurality of instructions. The plurality of instructions, when executed by a processor of a computer device, cause the computer device to perform the foregoing virtual object control method.

The technical solutions provided in the embodiments of this application include at least the following beneficial effects:

Before the first skill is cast, the second virtual object is determined based on the facing direction of the first virtual object, and the linear skill indicator of the first skill is automatically displayed between the first virtual object and the second virtual object, so that a player who controls the first virtual object can change the second virtual object by adjusting the facing direction of the first virtual object and a target object of the first skill is allowed to quickly lock and aim before the skill cast operation, thereby improving accuracy of casting the first skill.

### BRIEF DESCRIPTION OF THE DRAWINGS

FIG. 1 is a schematic structural diagram of a terminal according to an exemplary embodiment of this application.

FIG. 2 is a structural block diagram of a computer system according to an exemplary embodiment of this application.

FIG. 3 is a schematic diagram of an interface of a virtual object control method according to an exemplary embodiment of this application.

FIG. 4 is a flowchart of a virtual object control method according to an exemplary embodiment of this application.

FIG. 5 is a flowchart of a virtual object control method according to an exemplary embodiment of this application.

FIG. 6 is a schematic diagram of an interface of a virtual object control method according to an exemplary embodiment of this application.

FIG. 7 is a schematic diagram of an interface of a virtual object control method according to an exemplary embodiment of this application.

FIG. 8 is a schematic diagram of an interface of a virtual object control method according to an exemplary embodiment of this application.

FIG. 9 is a flowchart of a virtual object control method according to an exemplary embodiment of this application.

FIG. 10 is a schematic diagram of determining a position angle according to an exemplary embodiment of this application.

FIG. 11 is a schematic diagram of a relative distance according to an exemplary embodiment of this application.

FIG. 12 is a schematic diagram of an interface of a virtual object control method according to an exemplary embodiment of this application.

FIG. 13 is a flowchart of determining a second virtual object according to an exemplary embodiment of this application.

FIG. 14 is a flowchart of a virtual object control method according to an exemplary embodiment of this application.

FIG. 15 is a flowchart of a virtual object control apparatus according to an exemplary embodiment of this application.

FIG. 16 is a structural block diagram of a terminal according to an exemplary embodiment of this application.

### DESCRIPTION OF EMBODIMENTS

The method provided in the embodiments of this application is applicable in an application program with a virtual environment and a virtual object. For example, an application program that supports a virtual environment is an application program in which a user can control the movement of a virtual objects within the virtual environment. For example, the method provided in this application can be applied to: any program of a virtual reality (VR) application program, an augmented reality (AR) program, a three-dimensional map program, a VR game, an AR game, a first-person shooting (FPS) game, a third-person shooting (TPS) game, a multiplayer online battle arena (MOBA) game, and a simulation game (SLG).

For example, a game based on a virtual environment includes maps of one or more game worlds. The virtual environment in the game simulates scenes in the real world. A user may control a virtual object in the game to perform actions in the virtual environment such as walking, running, jumping, shooting, combatting, driving, using a virtual weapon to attack another virtual object hardly, and using a virtual weapon to attack another virtual object, which has relatively high interactivity. In addition, a plurality of users may form a team online to perform an arena game.

In some embodiments, the foregoing application programs may be programs such as a shooting game, a racing game, a role-playing game, an adventure game, a sandbox game, and a tactical arena game. The client may support at least one operating system of a Windows operating system, an Apple operating system, an Android operating system, an IOS operating system, and a LINUX operating system, and clients on different operating systems may be connected to and communicate with each other. In some embodiments, the foregoing client is a program adapted to a mobile terminal having a touchscreen.

In some embodiments, the foregoing client is an application program developed based on a three-dimensional engine. For example, the three-dimensional engine is a Unity engine.

A terminal in this application may be a desktop computer, a portable laptop computer, a mobile phone, a tablet computer, an ebook reader, a moving picture experts group audio layer III (MP3) player, a moving picture experts group audio layer IV (MP4) player, or the like. A client supporting a virtual environment is installed and run on the terminal, such as a client supporting a 3D virtual environment of the application program. The application program may be any one of a battle royale (BR) game, a VR application program, an AR program, a 3D map program, a TPS game, a FPS game, and a MOBA game. In some embodiments, the application program may be a standalone application program, such as a standalone 3D game program, or may be an online application program.

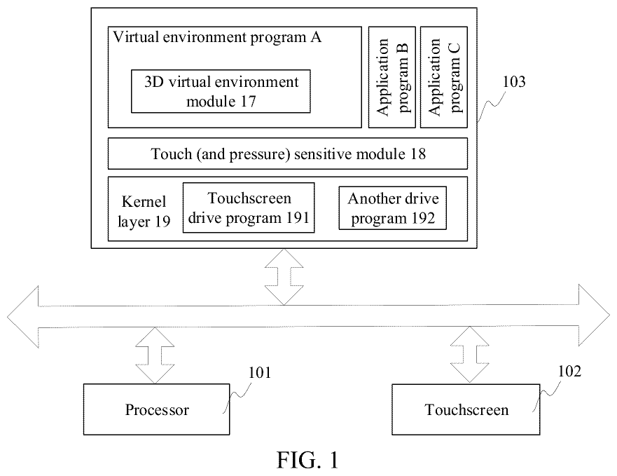

FIG. 1 is a schematic structural diagram of a terminal according to an exemplary embodiment of this application. The terminal includes a processor 101, a touchscreen 102, and a memory 103.

The processor 101 may be at least one of a single-core processor, a multi-core processor, an embedded chip, and a processor having an instruction running capability.

The touchscreen 102 includes a normal touchscreen or a pressure sensitive touchscreen. The common touchscreen can measure the pressing operation or sliding operation applied on the touchscreen 102; and the pressure sensitive touchscreen can measure pressing strength on the touchscreen 102.

The memory 103 stores programs executable by the processor 101. For example, the memory 103 stores a virtual environment program A, an application program B, an application program C, a touch (and pressure) sensitive module 18, and a kernel layer 19 of an operating system. The virtual environment program A is an application program developed based on a 3D virtual environment module 17. In some embodiments, the virtual environment program A includes, but is not limited to at least one of a game program, a virtual reality program, a three-dimensional map program, and a three-dimensional demonstration program that are developed by the 3D virtual environment module (also referred to as a virtual environment module) 17. For example, when an operating system of the terminal is an Android operating system, the virtual environment program A develops by using Java programming language and C # language. For another example, when an operating system of the terminal is an IOS operating system, the virtual environment program A develops by using Object-C programming language and C # language.

The 3D virtual environment module 17 is a module supporting a plurality of operating system platforms. For example, the 3D virtual environment module 17 may be applied to program development in a plurality of fields such as the game development field, the virtual reality (VR) field, and the three-dimensional map field. A specific type of the 3D virtual environment module 17 is not limited in this embodiment of this application. An example in which the 3D virtual environment module 17 is a module developed by using a Unity engine is used in the following embodiment for description.

The touch (and pressure) sensitive module 18 is a module configured to receive a touch event (and a pressure touch and control event) reported by a touchscreen drive program 191. In some embodiments, the touch sensitive module may not have a pressure sensitive function, and does not receive a pressure touch event. The touch event includes: a type and coordinate values of the touch event. The type of the touch (touch) event includes, but is not limited to: a touch start (touch start) event, a touch move (touch move) event, and a touch end (touch end) event. The pressure touch and control event includes: the pressure value and the coordinate values of the pressure touch and control event. The coordinate values are configured for indicating a touch and control position of a pressure touch and control operation on a display screen. In some embodiments, an x-axis is established in a horizontal direction of the display screen and a y-axis is established in a vertical direction of the display screen, and therefore, a two-dimensional coordinates system is obtained.

Schematically, the kernel layer 19 includes the touchscreen drive program 191 and another drive program 192. The touchscreen drive program 191 is a module configured to detect a pressure touch and control event. When detecting the pressure touch and control event, the touchscreen drive program 191 transfers the pressure touch and control event to the pressure sensing module 18.

The another drive program 192 may be a drive program related to the processor 101, a drive program related to the memory 103, a drive program related to a network component, a drive program related to a sound component, or the like.

A person skilled in the art may learn that the foregoing is only an overview of a structure of the terminal. In different embodiments, the terminal may have more or fewer components. For example, the terminal may further include a gravity acceleration sensor, a gyroscope sensor, a power supply, and the like.

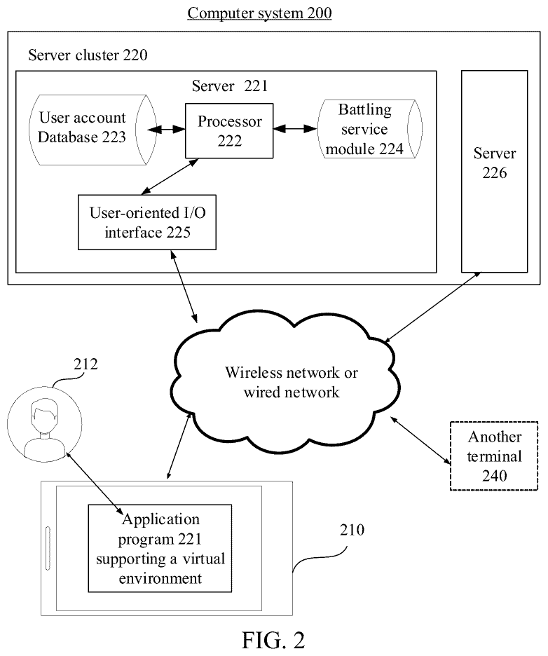

FIG. 2 is a structural block diagram of a computer system according to an exemplary embodiment of this application. A computer system 200 includes: a terminal 210 and a server cluster 220.

A client 211 supporting a virtual environment is installed and run on the terminal 210, and the client 211 may be an application program supporting the virtual environment. When the terminal runs the client 211, a user interface of the client 211 is displayed on a screen of the terminal 210. The client may be any one of a FPS game, a TPS game, a MOBA game, a tactical competitive game, and a SLG. In this embodiment, an example in which a client is a FPS game is used for description. The terminal 210 is a terminal used by a first user 212. The first user 212 uses the terminal 210 to control a first virtual object located in the virtual environment to perform a movement, and the first virtual object may be a first virtual character controlled by the first user 212. The activity of the first virtual character includes, but is not limited to: at least one of adjusting body postures, crawling, walking, running, riding, flying, jumping, driving, picking, shooting, attacking, and throwing. For example, the first virtual character is a simulated person character or a cartoon person character.

FIG. 2 shows only one terminal. However, a plurality of other terminals 240 exist in different embodiments. In some embodiments, there is at least one of other terminals 240 which is a terminal corresponding to the developer. A developing and editing platform for the client of the virtual environment is installed on the other terminals 240. The developer may edit and update the client on the other terminals 240 and transmit an updated client installation package to the server cluster 220 by using a wired or wireless network. The terminal 210 may download the client installation package from the server cluster 220 to update the client.

The terminal 210 and the other terminals 240 are connected to the server cluster 220 by using a wireless network or a wired network.

The server cluster 220 includes at least one of one server, a plurality of servers, a cloud computing platform, and a virtualization center. The server cluster 220 is configured to provide a background service for a client supporting a virtual environment. In some embodiments, the server cluster 220 is responsible for primary computing work, and the terminal is responsible for secondary computing work; or the server cluster 220 is responsible for secondary computing work, and the terminal is responsible for primary computing work; or a distributed computing architecture is adopted between the server cluster 220 and the terminal to perform collaborative computing.

In some embodiments, the foregoing terminals and servers are computer devices.

In a schematic example, the server cluster 220 includes a server 221 and a server 226. The server 221 includes a processor 222, a user account database 223, a battle service module 224, and a user-oriented input/output (I/O) interface 225. The processor 222 is configured to load instructions stored in the server 221, and process data in the user account database 223 and the battle service module 224. The user account database 223 is configured to store data of user accounts used by the terminal 210 and the other terminals 240, for example, avatars of the user accounts, nicknames of the user accounts, battle effectiveness indexes of the user accounts, and service zones of the user accounts. The battle service module 224 is configured to provide a plurality of battle rooms for the user to battle. The user-oriented I/O interface 225 is configured to establish communication with the terminal 210 via a wireless network or a wired network for data exchange.

In combination with the above introduction of the virtual environment and description of the implementation environment, the virtual object control method provided by the embodiments of this application will be described below.

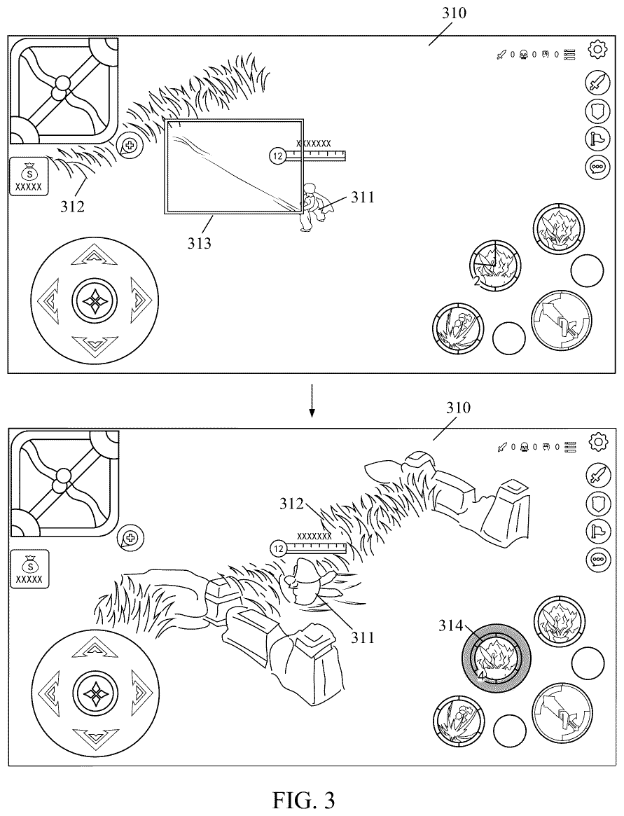

FIG. 3 is a schematic diagram of an interface of a virtual object control method according to an exemplary embodiment of this application.

A display interface 310 displays a first virtual object 311 and at least one candidate virtual object, and the first virtual object 311 has a first skill.

The candidate virtual object may be a virtual character or a virtual object in the display interface 310. When there are a plurality of candidate virtual objects, a second virtual object is one of the plurality of candidate virtual objects. In FIG. 3, an example in which the second virtual object is virtual grass 312 and the first skill is a displacement skill is used.

When the second virtual object is located within a skill cast range of the first skill, a linear skill indicator 313 of the displacement skill is displayed between the first virtual object 311 and the virtual grass 312, a first end of the linear skill indicator 313 is located on the first virtual object 311, and a second end of the linear skill indicator 313 is located on the virtual grass 312.

A player can adjust a facing direction of the first virtual object 311 through a rotation operation on the first virtual object 311, so that the first virtual object 311 can face the virtual grass 312. The facing direction of the virtual object refers to a direction in which the front of the virtual object faces. In some embodiments, as the facing direction of the first virtual object 311 changes, the virtual object pointed to by the linear skill indicator 313 is also different. For example, if the first virtual object 311 is adjusted to face a virtual wall, the linear skill indicator 313 between the first virtual object 311 and the virtual grass 312 is canceled, and the linear skill indicator (not shown in FIG. 3) of the displacement skill is displayed between the first virtual object 311 and the virtual wall.

When the first virtual object 311 moves relative to the virtual grass 312, the linear skill indicator 313 is updated and displayed, for example, at least one of a display length and a display position of the linear skill indicator 313 is updated and displayed.

In some embodiments, according to a line distance between the first virtual object 311 and the virtual grass 312, the display length of the linear skill indicator 313 is updated and displayed. It is assumed that the virtual grass 312 is located in the facing direction of the first virtual object 311, the player controls the first virtual object 311 to move along an extension direction of the facing direction, that is, to move towards the virtual grass 312, so that the line distance between the first virtual object 311 and the virtual grass 312 is shortened, and the display length of the linear skill indicator 313 is also shortened in this case. The player controls the first virtual object 311 to retreat relative to the virtual grass 312, so that the line distance between the first virtual object 311 and the virtual grass 312 increases, and in this case, the display length of the linear skill indicator 313 also increases.

In some embodiments, the display position of the linear skill indicator 313 is updated and displayed according to an inclination angle of the virtual grass 312 relative to the facing direction of the first virtual object 311. For another example, the virtual grass 312 is located in the northwest direction of the facing direction of the first virtual object 311, and the player still controls the first virtual object to move along the extension direction of the facing direction. In this case, the inclination angle of the virtual grass 312 relative to the facing direction of the first virtual object 311 gradually becomes larger, and the inclination angle of the display position of the linear skill indicator 313 relative to the facing direction of the first virtual object 311 also gradually becomes larger. In addition, the line distance between the first virtual object 311 and the virtual grass 312 is shortened, and in this case, the display length of the linear skill indicator 313 is shortened. Similarly, when the player controls the first virtual object 311 to retreat relative to the virtual grass 312, the inclination angle of the display position of the linear skill indicator 313 relative to the facing direction of the first virtual object 311 becomes gradually smaller, and the display length of the linear skill indicator 313 increases.

In response to a skill cast operation, the first virtual object 311 is controlled to cast the displacement skill to the virtual grass 312, and a skill cast effect of the displacement skill is displayed in the display interface 310, as shown in FIG. 3, the first virtual object 311 flies to the virtual grass 312.

The skill cast operation may be implemented based on a trigger operation on the skill control 314 corresponding to the displacement skill. In some embodiments, the skill control 314 may be displayed in the display interface 310, or may not be displayed in the display interface 310; or the skill control 314 is in a translucent display state in the display interface 310. When the skill control 314 is not displayed in the display interface 310, after the player taps the display interface 310, the skill control 314 is displayed in the display interface 310.

In some embodiments, before the first virtual object 311 is controlled to cast the first skill to the virtual grass 312, a prompt effect may be displayed on the virtual grass 312, and the prompt effect is used to indicate that the first skill is applied to the virtual grass 312.

The prompt effect includes at least one special effects of the following: a highlight special effect, a flicker special effect, an aperture special effect, and a color special effect. For example, after the player triggers the skill control 314, the virtual grass 312 is highlighted.

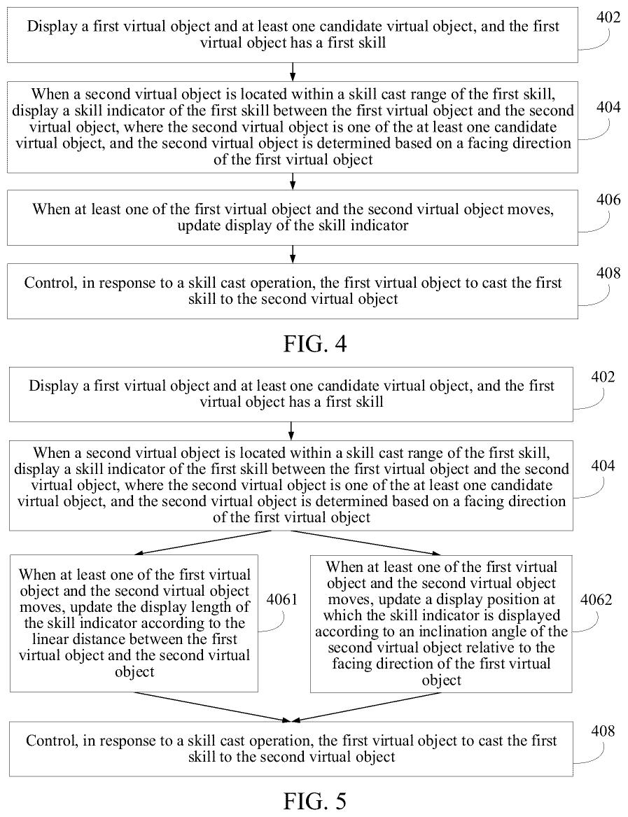

FIG. 4 is a flowchart of a virtual object control method according to an exemplary embodiment of this application, and the method may be applied to a terminal. The method includes the following steps:

Step 402: Display a first virtual object and at least one candidate virtual object, and the first virtual object has a first skill.

The first virtual object is a virtual character controlled by a first player. The candidate virtual object may be a virtual character controlled by a second player, or a virtual object not controlled by any player. For example, the display interface displays: a virtual character controlled by a first player, a virtual character controlled by a second player, a virtual grass, a virtual wall, a virtual house, and a virtual vehicle. The first virtual object may be the virtual character controlled by the first player, and the virtual character, the virtual grass, the virtual wall, the virtual house, and the virtual vehicle controlled by the second player are all candidate virtual objects.

In addition, there are dynamic virtual objects and static virtual objects in the virtual environment. For example, a dynamic virtual object can be controlled by a player or a server, such as a virtual character controlled by a player or a virtual monster controlled by a server; and The static virtual object may be a virtual object constituting the virtual environment, or a virtual object set in the virtual environment by the server or the player, such as a virtual wall or a virtual defensive building set by the player in the virtual environment.

Both the dynamic virtual object and the static virtual object may have a health value. For example, the virtual monster controlled by the server has a health value, and the virtual character controlled by the player casts skills to the virtual monster to reduce the health value of the virtual monster. For another example, the virtual defensive building set by the player may also have a health value, and other virtual characters that do not belong to the same camp as the player cast skills to the virtual defensive building, so that the health value of the virtual defensive building decreases, and when the health value drops to zero, the display of the virtual defensive building can be canceled to indicate that the virtual defensive building has been breached.

Based on the above content, the candidate virtual object may be a dynamic virtual object or a static virtual object; or may be a virtual object with a health value or a virtual object without a health value; or may be a virtual object set in the virtual environment by the player or a virtual object set in the virtual environment by the server.

In some embodiments, the candidate virtual object includes at least one of the following virtual objects: the virtual object controlled by the player, the virtual object controlled by the server, the virtual item constituting the virtual environment, the virtual item set by the player in the virtual environment, and the virtual item set by the server in the virtual environment. Both the virtual object and the virtual item include two cases of having a health value and not having a health value.

For example, the first skill is one of the skills possessed by the first virtual object, and the first skill can be determined according to actual needs. For example, the first skill is a displacement skill, a blood recovery skill, a flash skill, a virtual attack skill, and the like.

Step 404: When a second virtual object is located within a skill cast range of the first skill, display a linear skill indicator of the first skill between the first virtual object and the second virtual object, where the second virtual object is one of the at least one candidate virtual object, and the second virtual object is determined based on a facing direction of the first virtual object.

For example, the first end of the linear skill indicator is located on the first virtual object, and the second end of the linear skill indicator is located on the second virtual object.

The skill cast range of the first skill may be determined according to actual needs. For example, the skill cast range is a circular range with the first virtual object as the center and a radius of n, n can be set according to actual needs, and n is a positive integer.

In some embodiments, when there are a plurality of candidate virtual objects displayed in the display interface, a distance between the first virtual object and each candidate virtual object is obtained. Based on the distance between the first virtual object and the candidate virtual object, the candidate virtual object in the skill cast range is determined as a target virtual object. Subsequently, the second virtual object is determined from the target virtual objects.

For example, the second virtual object is a virtual object located in the facing direction of the first virtual object. When a plurality of second virtual objects are displayed in the facing direction of the first virtual object, the virtual object having the closest line distance to the first virtual object is determined as the second virtual object.

For another example, the second virtual object is determined according to a position angle of the first virtual object and at least one candidate virtual object. The position angle refers to an angle formed by a first ray and a second ray. The first ray is determined according to a first position and the facing direction of the first virtual object, and the second ray is determined according to the first position and the position of each candidate virtual object. It is assumed that at least one candidate virtual object includes a virtual object 1 and a virtual object 2, according to the foregoing definition of the first ray and the second ray, the position angle corresponding to the virtual object 1 is 10°, and the position angle corresponding to the virtual object 2 is 20°. Based on this, the virtual object with the smallest position angle may be determined as the second virtual object, that is, the virtual object 1 is determined as the second virtual object. In some embodiments, when there are a plurality of virtual objects with the smallest position angle, the virtual object with the closest line distance to the first virtual object is determined as the second virtual object. The position angle corresponding to the virtual object located in the facing direction of the first virtual object may be regarded as 0°, and the specific description of the position angle will be expanded later.

For another example, the second virtual object is determined according to the relative distance between the first virtual object and the at least one candidate virtual object. The relative distance refers to a vertical distance from the position of each candidate virtual object to the first ray. For the definition of the first ray, refer to the foregoing content. It is still assumed that the at least one candidate virtual object includes the virtual object 1 and the virtual object 2, according to the foregoing definition, the vertical distance from the position of the virtual object 1 to the first ray is 1 meter, and the vertical distance from the position of the virtual object 2 to the first ray is 1.3 meters, that is, the relative distance between virtual object 1 and the first virtual object is 1 meter, and the relative distance between the virtual object 2 and the first virtual object is 1.3 meters. Based on this, the virtual object with the smallest relative distance may be determined as the second virtual object, that is, the virtual object 1 is determined as the second virtual object. In some embodiments, when there are a plurality of virtual objects with the smallest relative distance, the virtual object with the smallest position angle may be determined as the second virtual object. The specific description about the relative distance will be expanded later.

For example, the linear skill indicator of the first skill is displayed before the cast of the first skill, and is used to indicate a cast direction or aiming direction of the first skill, so as to clearly indicate a target object of the first skill to the player in the display interface. The linear skill indicator is an implementation of the skill indicator. The linear skill indicator is displayed between the virtual object that casts the first skill and the virtual object that accepts the first skill, so as to display a caster, a receiver, and a cast direction of the first skill. In this embodiment of this application, the caster of the first skill is the first virtual object, and the receiver of the first skill is the second virtual object, that is, the second virtual object is the target object of the first skill, and the cast direction of the first skill is cast from the first virtual object to the second virtual object, then the linear skill indicator can point from the first virtual object to the second virtual object.

It should be understood that the display of the linear skill indicator of the first skill does not require the player to operate. After the second virtual object enters a skill coverage range of the first skill and before the first player controls the first virtual object to cast the first skill, the linear skill indicator is automatically displayed between the first virtual object and the second virtual object, used to prompt the first player that the target object of the first skill is the second virtual object, so that the first player can determine the target object in time. If the target object is not the object required by the first player, the first player can replace the second virtual object by adjusting the facing direction of the first virtual object.

The display style of the skill indicator can be determined according to actual needs. In some embodiments, the display style of the skill indicator is one of a line, an arrow, a branch, a lightning, a chain, a rope, or other graphics with a direction indicating function. For example, the display style of the skill indicator is a plurality of directional curves, and the extension direction of the plurality of curves points to the second virtual object. For another example, the display style of the skill indicator is a blinking one-way arrow, and a direction of the one-way arrow is a direction in which the second virtual object is located.

Alternatively, the display style of the linear skill indicator is at least one line, and the line may be a straight line or a curved line. A first end of the at least one line is located on the first virtual object and a second end is located on the second virtual object. For example, referring to FIG. 3, taking the second virtual object is a virtual grass 312 as an example, the display style of a linear skill indicator 313 is a plurality of curves shown in a box, and the extension direction of the plurality of curves points from the first virtual object 311 to the virtual grass.

In some embodiments, the linear skill indicator may be displayed in at least one of the following styles: a straight line, a plurality of straight lines, a curve, a plurality of curves, a pattern formed by twisting a plurality of curves, a lightning line, a chain, a rope, a dendritic line.

In the display style of the linear skill indicator, the line color change, line thickness, and color darkness can be adjusted according to the relative positional relationship between the first virtual object and the second virtual object. For example, depending on the first skill, the line color of the corresponding linear skill indicator is also different. For example, the linear skill indicator of a first skill 1 is a red straight line, the linear skill indicator of a first skill 2 is a pattern formed by twisting a red curve and a yellow curve, and the linear skill indicator of a first skill 3 is a colored lightning.

For another example, the line thickness of the linear skill indicator is adjusted according to the line distance between the first virtual object and the second virtual object. The closer the second virtual object is to the first virtual object, the thicker the line is; and the farther the second virtual object is from the first virtual object, the thinner the line is. Based on this, the player can control the distance between the first virtual object and the second virtual object according to a thickness of the line, so that the first skill can cast a required skill on the second virtual object. Referring to FIG. 3, the first virtual object 311 is gradually approaching the virtual grass 312, and the line of the linear skill indicator 313 can gradually become thicker, so as to remind the player controlling the first virtual object 311 that the distance between the two is shortening. Alternatively, the line thickness of the linear skill indicator could be reversed from the above example.

For another example, the line thickness of the linear skill indicator is adjusted according to the position angle or relative distance of the second virtual object relative to the first virtual object. For the related description of the position angle and the relative distance, refer to the foregoing content. When the position angle or relative distance of the second virtual object relative to the first virtual object gradually increases, the line of the linear skill indicator gradually becomes thinner; and When the position angle or relative distance of the second virtual object relative to the first virtual object gradually decreases, the line of the linear skill indicator gradually becomes thicker. Referring to FIG. 3, the player controls the first virtual object 311 to rotate, the facing direction of the first virtual object 311 changes from facing the virtual grass 312 to the left, and the line of the linear skill indicator 313 can gradually become thinner, so as to remind the player that the facing direction of the first virtual object 311 changes. Alternatively, the line thickness of the linear skill indicator could be reversed from the above example.

In some embodiments, when a first position angle is the minimum value among the plurality of position angles, the line thickness of the linear skill indicator is inversely proportional to the first position angle; or when a first relative distance is the minimum value among the plurality of relative distances, the line thickness of the linear skill indicator is inversely proportional to the first relative distance. The smaller the position angle or relative distance, the thicker the line is; and The larger the position angle or relative distance, the thinner the line is. The first position angle is a position angle of the second virtual object relative to the first virtual object, and the plurality of position angles are position angles of a plurality of candidate virtual objects relative to the first virtual object; and the first relative distance is the relative distance of the second virtual object relative to the first virtual object, and the plurality of relative distances are the relative distances of the plurality of candidate virtual objects relative to the first virtual object. The second virtual object is one of the plurality of candidate virtual objects.

In some embodiments, when the position angle or relative distance of the second virtual object relative to the first virtual object exceeds a preset value, the display of the linear skill indicator is canceled. In this case, when a third virtual object is displayed within the skill coverage range of the first skill, and the second position angle is smaller than the first position angle, or the second relative distance is smaller than the first relative distance, then the linear skill indicator is displayed between the first virtual object and the third virtual object. The line thickness of the linear skill indicator varies according to the relative position of the first virtual object and the third virtual object. The second position angle is a position angle of the third virtual object relative to the first virtual object, and the second relative distance is a relative distance of the third virtual object relative to the first virtual object.

In addition, the change in color darkness of the linear skill indicator is similar to the change in line thickness, which can be used as a reference. For example, the closer the second virtual object is to the first virtual object, the darker the color is; and the farther the second virtual object is from the first virtual object, the lighter the color is. For another example, when the position angle or relative distance between the second virtual object and the first virtual object gradually increases, the line color of the linear skill indicator gradually becomes lighter; and When the position angle or relative distance between the second virtual object and the first virtual object gradually decreases, the color of the linear skill indicator gradually becomes darker.

In some embodiments, the second virtual object includes at one of the following virtual objects: a virtual object with a health value; and a virtual object without a health value and not belonging to a same camp.

The virtual object with the health value may or may not belong to the same camp as the first virtual object. If the two belong to the same camp, the first skill cast by the first virtual object to the second virtual object is used to increase the health value of the second virtual object; and If the two do not belong to the same camp, the first skill cast by the first virtual object to the second virtual object is used to decrease the health value of the second virtual object.

A virtual object without a health value and not belonging to any camp refers to a virtual character or virtual item located in the virtual environment, such as a virtual monster, a virtual grass, a virtual house, a virtual vehicle, and the like displayed in the virtual environment.

According to different second virtual objects, the position of the second end of the linear skill indicator is different. Taking the second virtual object is a virtual object with a health value as an example, the second end of the linear skill indicator is located at one of a body, a sole, and a top of the head that are of the second virtual object; and Taking the second virtual object is a virtual grass in the virtual environment as an example, the second end of the linear skill indicator is located at one of a root, a waist, and a top portion that are of the virtual grass.

In some embodiments, the linear skill indicator is a spatial linear skill indicator, and step 404 can be implemented as follows:

Display the spatial linear skill indicator of the first skill between the first virtual object and the second virtual object, where a display position of the spatial linear skill indicator is higher than a virtual ground of a virtual environment.

The spatial linear skill indicator is suspended on a virtual ground to distinguish the spatial linear skill indicator from the displayed item on the virtual ground.

Referring to FIG. 3, taking the second virtual object is a virtual grass 312 as an example, the display style of a linear skill indicator 313 is a plurality of curves shown in a box, and the extension direction of the plurality of curves points from the first virtual object 311 to the virtual grass. The first ends of the plurality of lines are located on the body of the first virtual object 311, the second ends of the plurality of lines are located at the waist of the virtual grass, and the display positions of the plurality of lines are higher than the virtual ground in the virtual environment.

The display style of the spatial linear skill indicator is at least one line that is higher than the virtual ground in the virtual environment, and the relevant description of the at least one line can refer to the foregoing content.

In some embodiments, a height of the at least one line relative to the virtual ground may be determined according to the relative position of the first virtual object and the second virtual object and/or their own height.

For example, the display height of the spatial linear skill indicator is adjusted according to the line distance between the first virtual object and the second virtual object. The closer the second virtual object is to the first virtual object, the higher the display height of the spatial linear skill indicator is; and the farther the second virtual object is from the first virtual object, the lower the display height of the spatial linear skill indicator is. Alternatively, the display height could be reversed from the above example.

For another example, the display height of the spatial linear skill indicator is adjusted according to the position angle or relative distance of the second virtual object relative to the first virtual object. When the position angle or relative distance of the second virtual object relative to the first virtual object gradually increases, the display height of the spatial linear skill indicator gradually becomes lower; and When the position angle or relative distance of the second virtual object relative to the first virtual object gradually decreases, the display height of the spatial linear skill indicator gradually becomes higher. Alternatively, the display height could be reversed from the above example.

For another example, the display height of the spatial linear skill indicator is adjusted according to the heights of the first virtual object and the second virtual object. When the heights of the first virtual object and the second virtual object are the same, the spatial linear skill indicator is displayed on the same horizontal height. When the heights of the first virtual object and the second virtual object are different, the spatial linear skill indicator is displayed at the position where the first virtual object or the second virtual object is half the height from the virtual ground, or a line is drawn between the position where the first virtual object is half the height from the virtual ground and the position where the second virtual object is half the height from the virtual ground, and the line is the display position of the spatial linear skill indicator.

In some embodiments, when the first position angle is the minimum value among the plurality of position angles, or the first relative distance is the minimum value among the plurality of relative distances, the display height of the spatial linear skill indicator is inversely proportional to the first position angle or the first relative distance. The smaller the position angle or relative distance, the higher the display height of the spatial linear skill indicator is; and The larger the position angle or relative distance, the lower the display height of the spatial linear skill indicator is.

In some embodiments, when the position angle or relative distance of the second virtual object relative to the first virtual object exceeds a preset value, the display of the spatial linear skill indicator is canceled. In this case, when a third virtual object is displayed within the skill coverage range of the first skill, and the second position angle is smaller than the first position angle, or the second relative distance is smaller than the first relative distance, then the spatial linear skill indicator is displayed between the first virtual object and the third virtual object. The display height of the spatial linear skill indicator varies according to the relative position of the first virtual object and the third virtual object.

When the linear skill indicator is a spatial linear skill indicator, the display position of the spatial linear skill indicator is higher than the virtual ground in the virtual environment, so that the display of the linear indicator in the display interface is more realistic and enhances the experience of the user.

Step 406: When at least one of the first virtual object and the second virtual object moves, update display of the linear skill indicator.

In some embodiments, when at least one of the first virtual object and the second virtual object moves, at least one of display of a display length and a display position of the linear skill indicator is updated.

At least one of the first virtual object and the second virtual object is the first virtual object and/or the second virtual object. The display length and the display position of the linear skill indicator changes according to changes in the relative position of the first virtual object and the second virtual object. The change of the relative position of the first virtual object and the second virtual object may be a change of the line distance, such as the first virtual object or the second virtual object approaches or moves away from each other; or if the second virtual object is a static virtual object, the change of the relative position of the first virtual object and the second virtual object is a change caused by the movement of the first virtual object relative to the second virtual object.

For example, the movement of the first virtual object is realized by the first player controlling the first virtual object performing a movement operation on the first virtual object; and the movement of the second virtual object is realized by the second player controlling the second virtual object performing a movement operation on the second virtual object.

Referring to FIG. 3, the display length of the linear skill indicator 313 refers to an overall length of a graph composed of a plurality of curves. In some embodiments, the update of the display of the display length of the linear skill indicator 313 may be performed according to the line distance between the first virtual object 311 and the virtual grass 312.

An example in which the virtual grass 312 is located in the facing direction of the first virtual object 311 is used. The player controls the first virtual object 311 to move close to the virtual grass 312 along the extension direction of the facing direction. In this case, the line distance between the first virtual object 311 and the virtual grass 312 is shortened. Correspondingly, the display length of the linear skill indicator 313 is also shortened. Alternatively, the player controls the first virtual object 311 to retreat relative to the virtual grass 312. In this case, the line distance between the first virtual object 311 and the virtual grass 312 increases. Correspondingly, the display length of the linear skill indicator 313 also increases.

In some embodiments, the display position of the linear skill indicator 313 is updated and displayed according to an inclination angle of the virtual grass 312 relative to the facing direction of the first virtual object 311.

An example in which the virtual grass 312 is located in the northwest direction of the facing direction of the first virtual object 311 is used. The player still controls the first virtual object to move along the extension direction of the facing direction. In this case, the inclination angle of the virtual grass 312 relative to the facing direction of the first virtual object 311 gradually becomes larger, and the inclination angle of the display position of the linear skill indicator 313 relative to the facing direction of the first virtual object 311 also gradually becomes larger. Since the virtual grass 312 cannot be moved, in the display interface 310, the player can observe that the second end of the linear skill indicator 313 remains on the virtual grass 312, and the first end moves with the first virtual object 311, so that the player can observe that the display position of the linear skill indicator 313 is gradually inclined, and the inclination angle of the display position of the linear skill indicator 313 relative to the facing direction of the first virtual object 311 is gradually increased. In addition, the line distance between the first virtual object 311 and the virtual grass 312 is shortened, and in this case, the display length of the linear skill indicator 313 is shortened.

Similarly, when the player controls the first virtual object 311 to retreat relative to the virtual grass 312, the inclination angle of the display position of the linear skill indicator 313 relative to the facing direction of the first virtual object 311 becomes gradually smaller, and the display length of the linear skill indicator 313 increases. Similarly, since the virtual grass 312 cannot be moved, in the display interface 310, the player can observe that the second end of the linear skill indicator 313 remains on the virtual grass 312, and the first end moves with the first virtual object 311, so that the player can observe that the display position of the linear skill indicator 313 is gradually inclined, and the inclination angle of the display position of the linear skill indicator 313 relative to the facing direction of the first virtual object 311 is gradually smaller.

Step 408: Control, in response to a skill cast operation, the first virtual object to cast the first skill to the second virtual object.

The skill cast operation refers to an operation of triggering the first skill.

For example, when the first virtual object is controlled to cast the first skill to the second virtual object or after casting the skill, the skill cast special effect of the first skill may be displayed.

In some embodiments, the skill cast operation is implemented based on a trigger operation on the skill control corresponding to the first skill, and the skill control may be displayed in the same interface as the first virtual object, or may not be displayed in the display interface.

For example, the skill control is in a translucent state in the display interface, and the player clicks the skill control to realize the skill cast operation. For another example, the skill control is in a translucent state in the display interface, and the player touches the display interface or clicks the display interface to display the skill control in the display interface. Subsequently, in response to a trigger operation on the skill control, the first virtual object is controlled to cast the first skill to the second virtual object, and the skill cast special effect of the first skill is displayed in the display interface. Alternatively, the player touches or clicks a region at which the skill control is located, the first virtual object is controlled to cast the first skill to the second virtual object, and the skill cast special effect of the first skill is displayed in the display interface.

In some embodiments, when the skill cast operation is implemented based on a trigger operation on the skill control corresponding to the first skill, step 404 may be implemented as: When the second virtual object is located in the skill cast range of the first skill, in response to a touch down operation on a skill control corresponding to the first skill, the linear skill indicator of the first skill is displayed between the first virtual object and the second virtual object. Step 408 may be implemented as: Control, in response to a termination of the touch down operation on the skill control, the first virtual object to cast the first skill to the second virtual object. For example, the touch down operation may be a touch start operation, and the termination of the touch down operation may be a touch end operation.

Referring to FIG. 3, a skill control 314 is displayed in the display interface 310. If the player touches the skill control 314 and does not cast it, a linear skill indicator 313 may be displayed between the first virtual object 311 and the virtual grass 312. If the virtual grass 312 is not the target object of the first skill that the player wants, the player can adjust the facing direction of the first virtual object 311 without casting the touch skill control 314 to replace the target object of the first skill; and After the target object is determined, the player can cast it to realize the termination of the touch down operation on the skill control 314. In this case, the display of the linear skill indicator 313 may be maintained, or the display of the linear skill indicator 313 may be canceled, and the first virtual object 311 may be controlled to cast the first skill to the virtual grass 312, and the skill cast special effect of the first skill is displayed in the display interface 310.

In conclusion, in the virtual object control method provided in the embodiments of this application, before the first skill is cast, the second virtual object is determined based on the facing direction of the first virtual object, and the linear skill indicator of the first skill is automatically displayed between the first virtual object and the second virtual object, so that a player who controls the first virtual object can change the second virtual object by adjusting the facing direction of the first virtual object and a target object of the first skill is allowed to quickly lock and aim before the skill cast operation, thereby improving accuracy of casting the first skill.

An example in which the first player controls the first virtual object and the second player controls the second virtual object is used, the movement of the first virtual object and/or the second virtual object will lead to various situations. For example, the first virtual object and the second virtual object are close to each other. For another example, the first virtual object is far away from the second virtual object. For another example, the second virtual object is beyond the skill cast range of the first skill of the first virtual object. According to different situations, the display of the linear skill indicator is different.

Based on FIG. 4, FIG. 5 is a flowchart of a virtual object control method according to an exemplary embodiment of this application. Step 406 can be implemented as step 4061 and/or step 4062, specifically as follows:

Step 4061: When at least one of the first virtual object and the second virtual object moves, update the display length of the linear skill indicator according to the line distance between the first virtual object and the second virtual object.

The line distance between the first virtual object and the second virtual object refers to the distance between the first position at which the first virtual object is located and the position at which the second virtual object is located, and the line distance between the first virtual object and the second virtual object is not affect by the virtual obstacle between the two.

In some embodiments, step 4061 may be implemented as: When the first virtual object or the second virtual object is approaching each other, the display length of the linear skill indicator is shortened; or when the first virtual object or the second virtual object moves away from each other, the display length of the linear skill indicator increases.

For example, as the first virtual object is relatively close to the second virtual object, the display length of the linear skill indicator is shortened; and as the first virtual object is relatively far from the second virtual object, the display length of the linear skill indicator increases.

When the second virtual object is a dynamic virtual object, both the first virtual object and the second virtual object can move in the virtual environment, which may cause the line distance between the first virtual object and the second virtual object to change, and in this case, the display length of the linear skill indicator needs to be updated; and when the second virtual object is a static virtual object, the first virtual object can move in the virtual environment, and the position of the second virtual object in the virtual environment remains unchanged, which may still cause the line distance between the first virtual object and the second virtual object to change, and in this case, the display length of the linear skill indicator needs to be updated as well.

For example, the second virtual object is displayed in the facing direction of the first virtual object, the first player controls the first virtual object to move toward the second virtual object, and the second player controls the second virtual object to move toward the first virtual object. In this case, the line distance between the first virtual object and the second virtual object will shorten rapidly. Based on the fact that the first end of the linear skill indicator is located on the first virtual object and the second end is located on the second virtual object, the display length of the linear skill indicator is updated and rapidly shortened.

For another example, the second virtual object is displayed in the facing direction of the first virtual object, the first player controls the first virtual object to move toward the second virtual object, and the second virtual player cannot move. Similar to the foregoing example, the line distance between the first virtual object and the second virtual object is gradually shortened, and the display length of the linear skill indicator is also gradually shortened.

For example, the increase of the display length of the linear skill indicator is similar to the decrease of the display length of the linear skill indicator, which can be used as a reference and will not be repeated here.

Step 4062: When at least one of the first virtual object and the second virtual object moves, a display position at which the linear skill indicator is displayed is updated according to an inclination angle of the second virtual object relative to the facing direction of the first virtual object.

According to the related description about the position angle in the foregoing content, the inclination angle of the second virtual object relative to the facing direction of the first virtual object can also be determined according to the first ray and the second ray.

An example in which the first ray is determined according to the first position and the facing direction of the first virtual object, and the second ray is determined according to the first position and the position of the second virtual object is used. The first ray is determined according to an extension line of the first position in the facing direction, for example, starting from the first position, a ray is determined in the facing direction of the first virtual object, which is the first ray; and The second ray is determined according to a line connecting the first position and the position at which the second virtual object is located. For example, starting from the first position, a ray is determined in the direction of the position at which the first position points to the second virtual object, which is the second ray. Subsequently, the angle formed by the first ray and the second ray is determined as an inclination angle of the second virtual object relative to the facing direction of the first virtual object.

According to the foregoing description, it should be understood that the inclination angle of the second virtual object relative to the facing direction of the first virtual object is the position angle of the second virtual object relative to the first virtual object.

In some embodiments, step 4062 may be implemented as: When the inclination angle becomes larger, increase the inclination angle of the display position of the linear skill indicator relative to the facing direction of the first virtual object; or when the inclination angle becomes smaller, decrease the inclination angle of the display position of the linear skill indicator relative to the facing direction of the first virtual object.

In an implementation scenario, the second virtual object is not in the facing direction of the first virtual object. In this case, according to the movement of the first virtual object and/or the second virtual object, the inclination angle of the second virtual object relative to the facing direction of the first virtual object also changes.

When the second virtual object is a dynamic virtual object, both the first virtual object and the second virtual object can move in the virtual environment, which may cause the inclination angle corresponding to the second virtual object to change, and in this case, the display of the display position of the linear skill indicator needs to be updated; and when the second virtual object is a static virtual object, the first virtual object can move in the virtual environment, and the position of the second virtual object in the virtual environment remains unchanged, which may still cause the inclination angle corresponding to the second virtual object changes, and in this case, the display of the display position of the linear skill indicator needs to be updated as well.

For example, the second virtual object is displayed in the northwest direction of the first virtual object, the first player controls the first virtual object to move toward the second virtual object, and the second virtual object cannot be moved. In this case, the second virtual object gradually approaches the first virtual object, and the inclination angle of the second virtual object relative to the facing direction of the first virtual object gradually becomes larger.

In this time, based on the fact that the first end of the linear skill indicator is located on the first virtual object and the second end is located on the second virtual object, the player can observe the change of the linear skill indicator in the display interface. An example in which the display style of the linear skill indicator is a line is used, the first end of the linear skill indicator moves synchronously with the first virtual object, the second end remains on the second virtual object, the line length of the linear skill indicator gradually inclines, and the inclination range changes with the movement of the first virtual object.

Similarly, the change of the inclination angle of the display position of the linear skill indicator relative to the facing direction of the first virtual object becomes smaller, which is similar to the inclination angle of the display position of the linear skill indicator relative to the facing direction of the first virtual object, which can be used as a reference and will not be repeated here.

It should be understood that, step 4061 and step 4062 can be performed alternatively, or can be performed simultaneously. For example, when the first virtual object and/or the second virtual object moves, the display of the display length of the linear skill indicator is updated according to the line distance between the first virtual object and the second virtual object; and the display of the display position of the linear skill indicator is updated according to the inclination angle of the second virtual object relative to the facing direction of the first virtual object.

Other possibilities exist when the first virtual object and/or the second virtual object moves. For example, the facing direction of the first virtual object changes significantly. For another example, the second virtual object moves so that the second virtual object is beyond the skill cast range of the first skill of the first virtual object.

In some embodiments, the virtual object control method provided in embodiments of this application may further include: canceling, when a change magnitude of the facing direction of the first virtual object is greater than a change condition, the display of the linear skill indicator; or canceling, when the second virtual object is beyond the skill cast range of the first skill, the display of the linear skill indicator.

The change condition can be set according to actual needs. For example, the change condition is that the change magnitude of the facing direction of the first virtual object is greater than or equal to a change magnitude threshold. For another example, the change condition is that the facing direction of the first virtual object changes. Referring to FIG. 3, an example in which the change condition is that the change magnitude of the facing direction of the first virtual object 311 is not less than 90° is used. The player controls the first virtual object 311 to rotate, and the facing direction of the first virtual object 311 is changed from facing southeast to facing northwest. Since the change magnitude of the facing direction of the first virtual object 311 is 180°, the change condition is met. Then the display of the linear skill indicator 313 is canceled.

In some embodiments, the virtual object control method provided in embodiments of this application may further include: canceling, when the facing direction of the first virtual object is changed from facing the second virtual object to facing a third virtual object, the display of the linear skill indicator between the first virtual object and the second virtual object, and displaying the linear skill indicator between the first virtual object and the third virtual object. The third virtual object is another one of the at least one candidate virtual object, and the third virtual object is located in the skill cast range of the first skill. There are a plurality of candidate virtual objects, and the third virtual object is one of the plurality of candidate virtual objects except the second virtual object.

An example in which the second virtual object is a virtual grass and the third virtual object is a virtual city wall is used. In an initial state, the facing direction of the first virtual object is toward the virtual grass. Subsequently, the player controls the movement of the first virtual object, so that the facing direction of the first virtual object is changed from facing the virtual grass to facing the virtual city wall. Based on this change, the display of the linear skill indicator between the first virtual object and the virtual grass is canceled, and the linear skill indicator is displayed between the first virtual object and the virtual city wall. The player can observe that in the display interface, the linear skill indicator between the first virtual object and the virtual grass disappears, and in addition, a linear skill indicator is displayed between the first virtual object and the virtual city wall.

In conclusion, the virtual object control method provided in the embodiments of this application provides a change in the display length and/or display position of the linear skill indicator. The display of the display length of the linear skill indicator is updated according to the line distance between the first virtual object and the second virtual object; and The display of the display position of the linear skill indicator is updated according to the inclination angle of the second virtual object relative to the facing direction of the first virtual object. The embodiments of this application also provide the cancel of the display of the linear skill indicator and the display of the linear skill indicator when the facing direction of the first virtual object changes.

Based on the change in the display of the linear skill indicator given, the virtual object control method provided in the embodiments of this application can make the display of the linear skill indicator more realistic, and can provide the change of the target object of the first skill to the player who controls the first virtual object, so as to further improve the accuracy of casting the first skill.

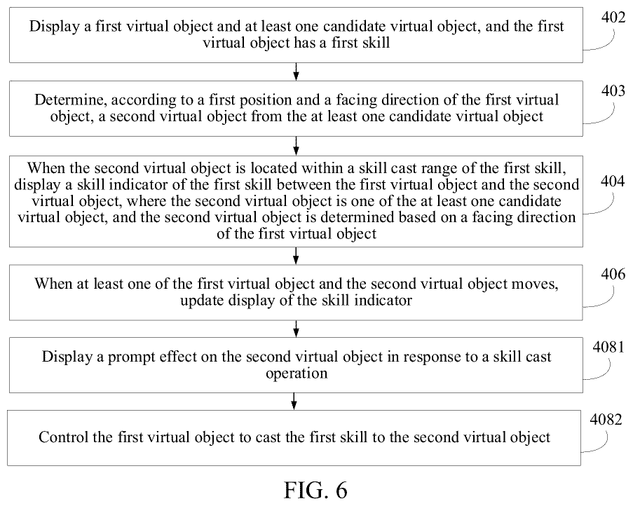

Based on FIG. 4, FIG. 6 is a flowchart of a virtual object control method according to an exemplary embodiment of this application. The method further includes step 403, and step 408 can be implemented as step 4081 and step 4082, specifically as follows:

Step 403: Determine, according to a first position and the facing direction of the first virtual object, the second virtual object from the at least one candidate virtual object.

The facing direction of the first virtual object refers to a direction in which the face of the first virtual object faces. For example, if the face of the first virtual object faces southeast, then the facing direction of the first virtual object is the southeast direction.

In some embodiments, the second virtual object may be determined from target virtual objects in at least one candidate virtual object. The target virtual object is located in the skill cast range of the first skill, and the determination of the target virtual object can be implemented as follows: Obtain a distance between the first virtual object and each candidate virtual object; and determine, based on the distance between the first virtual object and the candidate virtual object, the candidate virtual object in the skill cast range as the target virtual object.

For example, according to the first position of the first virtual object, the skill cast range of the first skill may be determined. Subsequently, when a quantity of target virtual objects is 1, the target virtual object may be determined as the second virtual object; and when the quantity of target virtual objects exceeds 1, the second virtual object may be determined according to the first position and the facing direction of the first virtual object.

The facing direction of the first virtual object changes according to the movement of the first virtual object in the virtual environment. In some embodiments, the virtual object control method provided in embodiments of this application may further include: Adjust, in response to a turning operation on the first virtual object, the facing direction of the first virtual object, so that the facing direction of the first virtual object can face the second virtual object.

An example in which the first player controls the first virtual object is used, if the first player controls the first virtual object to turn left by 15°, then the facing direction of the first virtual object is adjusted to the left by 15°. It is assumed that a virtual object 1 is displayed in an original facing direction of the first virtual object, and a virtual object 2 is displayed in an adjusted facing direction. Then, before the facing direction of the first virtual object is adjusted, a linear skill indicator is displayed between the first virtual object and the virtual object 1; and after the facing direction of the first virtual object is adjusted, the linear skill indicator is displayed between the first virtual object and the virtual object 2.

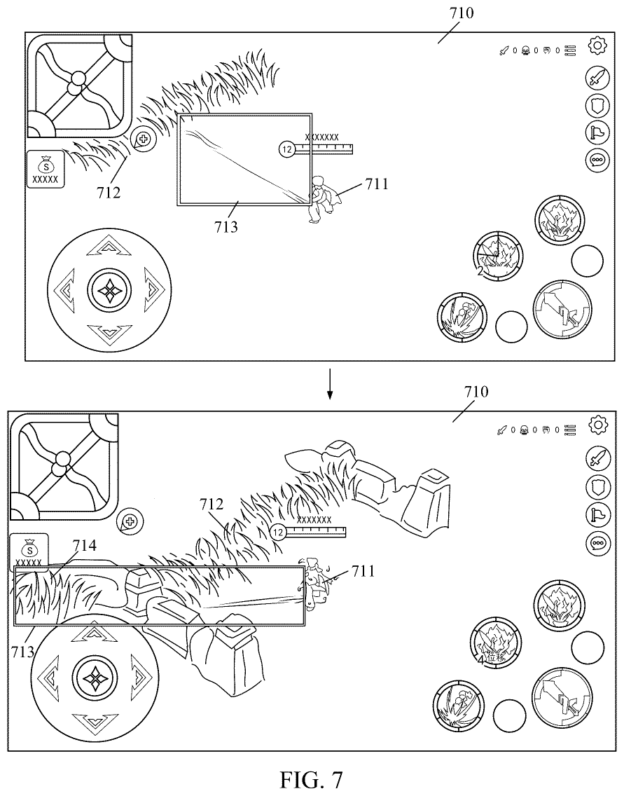

FIG. 7 is a schematic diagram of an interface of a virtual object control method according to an exemplary embodiment of this application. A display interface 710 displays a first virtual object 711 and a candidate virtual object 712 (that is, a first virtual grass), and the first virtual object 711 has the first skill. An example in which the second virtual object is the first virtual grass before the facing direction of the first virtual object 711 is adjusted is used. Referring to FIG. 7, a linear skill indicator 713 is displayed between the first virtual object 711 and the first virtual grass. Subsequently, the first player controls the first virtual object 711 to turn, so that the first virtual object 711 faces a second virtual grass pointed by a third virtual object 714. Correspondingly, the display of the linear skill indicator 713 between the first virtual object 711 and the first virtual grass is canceled, and the linear skill indicator 713 is displayed between the first virtual object 711 and the second virtual grass. For the specific determination of the second virtual object, reference may be made to the foregoing content, and details are not repeated here.

Step 4081: Display a prompt effect on the second virtual object in response to the skill cast operation.

For example, the prompt effect is used to indicate that the target object of the first skill is the second virtual object. It should be understood that the prompt effect is displayed after the skill cast operation.

An example in which the skill cast operation is implemented through a trigger operation on the skill control is used, a display sequence of the linear skill indicator and the prompt effect is as follows:

After the second virtual object enters the skill cast range of the first skill of the first virtual object, a linear skill indicator of the first skill is displayed between the first virtual object and the second virtual object. In this case, the first player who controls the first virtual object can obtain, according to the linear skill indicator, that the current target object of the first skill is the second virtual object. Subsequently, if the first player wants to change the target object, the first player can adjust the facing direction of the first virtual object through the turning operation on the first virtual object, thereby replacing the second virtual object. In this case, the display of the linear skill indicator changes accordingly. After the first player determines the target object of the first skill, that is, after the second virtual object is determined, the player triggers the skill control. Subsequently, in response to a trigger operation on the skill control, a prompt effect is displayed on the second virtual object, and the target object of the first skill is prompted again to the first player. In some embodiments, the prompt effect includes at least one special effects of the following: a highlight special effect, a flicker special effect, an aperture special effect, and a color special effect.

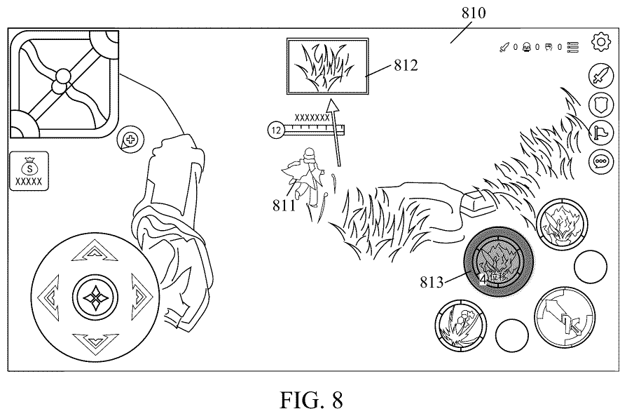

FIG. 8 is a schematic diagram of an interface of a virtual object control method according to an exemplary embodiment of this application. A display interface 810 displays a first virtual object 811 and a candidate virtual object 812. An example in which the second virtual object is the candidate virtual object (virtual grass) 812 as is used. In response to a trigger operation on the skill control 813, a prompt effect is displayed on the virtual grass to prompt that the virtual grass is the target object of the displacement skill.

For example, the prompt effect is a highlight special effect, after the player triggers the skill control 813, a highlight appears on the virtual grass. For another example, the prompt effect is a flicker effect, after the player triggers the skill control 813, the virtual grass begins to flash, the flicker time can be set according to actual needs. For another example, the prompt effect is an aperture special effect, and after the player triggers the skill control 813, an aperture appears around the virtual grass.

Step 4082: Control the first virtual object to cast the first skill to the second virtual object.

For example, when the first virtual object is controlled to cast the first skill or after casting the first skill, the skill cast special effect of the first skill may be displayed. The skill cast special effect and the prompt effect may be displayed at the same time; or the prompt effect is displayed first, and then the skill cast special effect is displayed. The display duration of the prompt effect can be set according to actual needs.

Referring to FIG. 8, an example in which the first skill is a displacement skill is used, after the player triggers the skill control 813, a highlight appears on the virtual grass, and after the highlight lasts for 2 seconds, the skill cast special effect can be displayed while the first virtual object is controlled to cast the displacement skill. The skill cast special effect is that the first virtual object 811 flies to a position at which the virtual grass is located along a direction of an arrow.

In conclusion, in the virtual object control method provided in the embodiments of this application, the second virtual object is determined by the first position and the facing direction of the first virtual object, so as to display a linear skill indicator. The facing direction of the first virtual object can be adjusted by the turning operation on the first virtual object, so that the player can adjust the facing direction of the first virtual object to select the target object on which the first skill is cast, further improving the accuracy of casting the first skill. In addition, in response to the skill cast operation, a prompt effect may also be displayed on the second virtual object, so as to remind the player again that the target object of the first skill is the second virtual object.

According to the foregoing content, the second virtual object can be determined by two ways of a position angle and a relative distance.

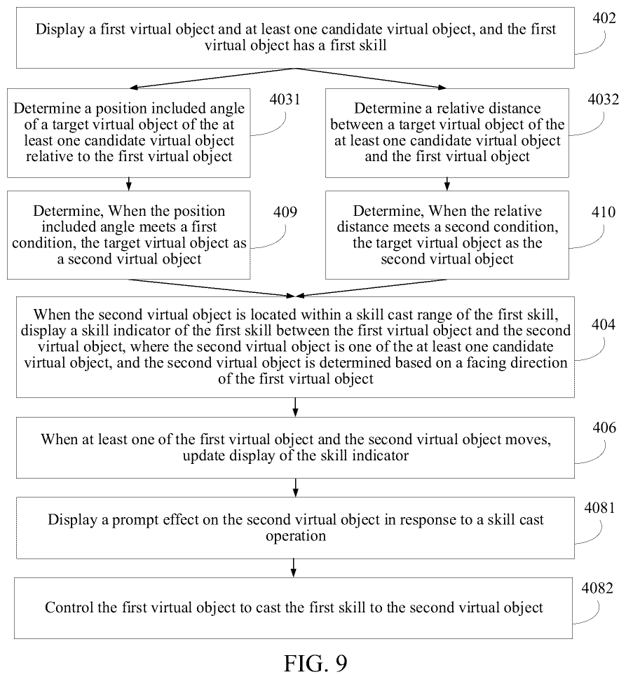

Referring to FIG. 6, FIG. 9 is a flowchart of a virtual object control method according to an exemplary embodiment of this application. When the second virtual object is determined by the position angle, step 403 can be implemented as step 4031 and step 409. When the second virtual object is determined by a relative distance, step 403 may be implemented as step 4032 and step 410.

In some embodiments, the determination of the second virtual object has the following two implementations:

Implementation 1: The second virtual object is determined by the position angle.

Step 4031: Determine a position angle of a target virtual object of the at least one candidate virtual object relative to the first virtual object.

For the relevant description of the target virtual object, refer to the foregoing content, and details will not be repeated here.

In some embodiments, the position angle is determined according to the relative position of the first virtual object and the target virtual object, and step 4031 can be implemented as follows: The angle formed by the first ray and the second ray is determined as the position angle, the first ray is determined according to the first position and the facing direction, and the second ray is determined according to the first position and the second position of the target virtual object.

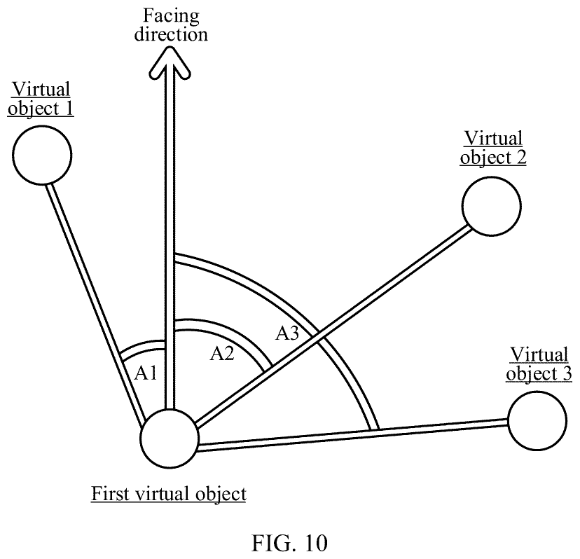

FIG. 10 is a schematic diagram of determining a position angle according to an exemplary embodiment of this application. An example in which at least one candidate virtual object includes a virtual object 1, a virtual object 2, and a virtual object 3 is used.

After the first position and the facing direction of the first virtual object are determined, the first ray can be determined. Referring to FIG. 10, the first position is a position of a circle at which the first virtual object is located, and the direction pointed by the arrow is the facing direction, then the first ray is a ray extending from the first position to the facing direction. Subsequently, according to the second positions corresponding to the virtual object 1, the virtual object 2, and the virtual object 3, three second rays can be determined. Taking the second ray corresponding to the virtual object 1 as an example, the second ray is a ray extending from the first position to the position of the circle at which the virtual object 1 is located. It is assumed that the virtual object 1 is a target virtual object determined from at least one candidate virtual object, an angle A1 formed by the first ray and the second ray corresponding to the virtual object 1 can be determined as a position angle of the target virtual object relative to the first virtual object.

Step 409: Determine, when the position angle meets a first condition, the target virtual object as the second virtual object.

In some embodiments, the first condition includes at least one of the following conditions: a value of the position angle is a smallest value of position angles corresponding to at least two target virtual objects; and a value of the position angle is less than a first preset value. The first preset value may be determined according to actual needs.

When a quantity of target virtual objects is at least two, and at least two position angles may be obtained, the target virtual object corresponding to a smallest position angle is determined as the second virtual object.

Referring to FIG. 10, an example in which at least one candidate virtual object includes a virtual object 1, a virtual object 2, and a virtual object 3 is used. It is assumed that the foregoing three virtual objects are all target virtual objects, according to the foregoing definition of the first ray and the second ray, the three position angles corresponding to the virtual object 1, the virtual object 2, and the virtual object 3 respectively can be determined, and the three position angles are an angle A1, an angle A2, and an angle A3 respectively. When the first condition includes that a value of the position angle is the minimum value among the position angles corresponding to at least two target virtual objects, referring to FIG. 10, a value of the angle 1 is the minimum value among the three position angles, then the virtual object 1 corresponding to the angle 1 is determined as the second virtual object.

Implementation 2: The second virtual object is determined by the relative distance.

Step 4032: Determine a relative distance between a target virtual object of the at least one candidate virtual object and the first virtual object.

For example, a relative distance of a target virtual object in at least one candidate virtual object relative to the first virtual object is determined. For the relevant description of the target virtual object, refer to the foregoing content, and details will not be repeated here.

In some embodiments, the relative distance is determined according to the relative position of the first virtual object and the target virtual object, and step 4032 can be implemented as follows: Determine a first ray according to the first position and the facing direction; and determine a vertical distance between a second position of the target virtual object and the first ray as the relative distance.

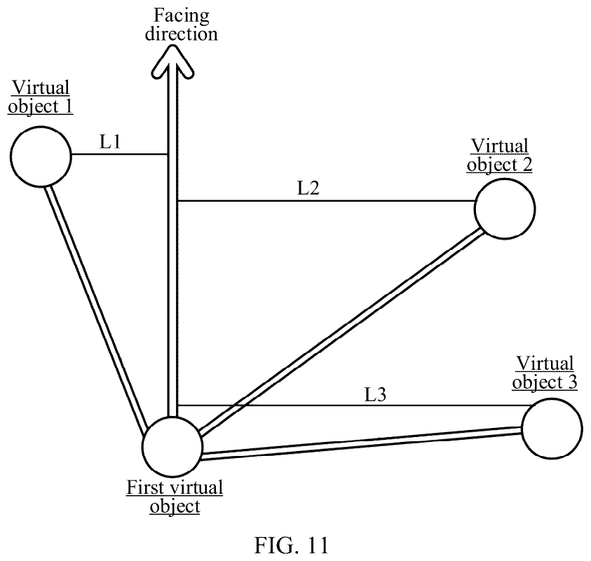

FIG. 11 is a schematic diagram of determining a relative distance according to an exemplary embodiment of this application. An example in which at least one candidate virtual object includes a virtual object 1, a virtual object 2, and a virtual object 3 is used. After the first position and the facing direction of the first virtual object are determined, the first ray can be determined. Referring to FIG. 11, the first position is a position of a circle at which the first virtual object is located, and the direction pointed by the arrow is the facing direction, then the first ray is a ray extending from the first position to the facing direction. Subsequently, according to the second positions corresponding to the virtual object 1, the virtual object 2, and the virtual object 3, three relative distances can be determined. Taking the relative distance corresponding to the virtual object 1 as an example, a vertical line L1 is drawn from the circle position of the virtual object 1 to the first ray, a length of the vertical line L1 is a vertical distance from the second position of the virtual object 1 to the first ray, and the length of the vertical line L1 is determined as the relative distance corresponding to the virtual object 1. It is assumed that the virtual object 1 is a target virtual object determined from at least one candidate virtual object, the distance L1 corresponding to the vertical line L1 may be determined as the relative distance of the target virtual object relative to the first virtual object.

Step 410: Determine, when the relative distance meets a second condition, the target virtual object as the second virtual object.

In some embodiments, the second condition includes at least one of the following conditions: a value of the relative distance is a smallest value of vertical distances corresponding to at least two target virtual objects; and a value of the relative distance is less than a second preset value. The second preset value may be determined according to actual needs.

When a quantity of target virtual objects is at least two, and at least two relative distances may be obtained, the target virtual object corresponding to a smallest relative distance is determined as the second virtual object.

Referring to FIG. 11, an example in which at least one candidate virtual object includes a virtual object 1, a virtual object 2, and a virtual object 3 is used. It is assumed that the foregoing three virtual objects are all target virtual objects, according to the foregoing definition of the relative distance, the three relative distances corresponding to the virtual object 1, the virtual object 2, and the virtual object 3 respectively can be determined, and the three relative distances are a distance L1, a distance L2, and a distance L3 respectively. When the second condition includes that a value of the relative distance is the minimum value among the vertical distances corresponding to at least two target virtual objects, referring to FIG. 11, a length of the distance L1 is the minimum value among the three relative distances, then the virtual object 1 corresponding to the distance L1 is determined as the second virtual object.

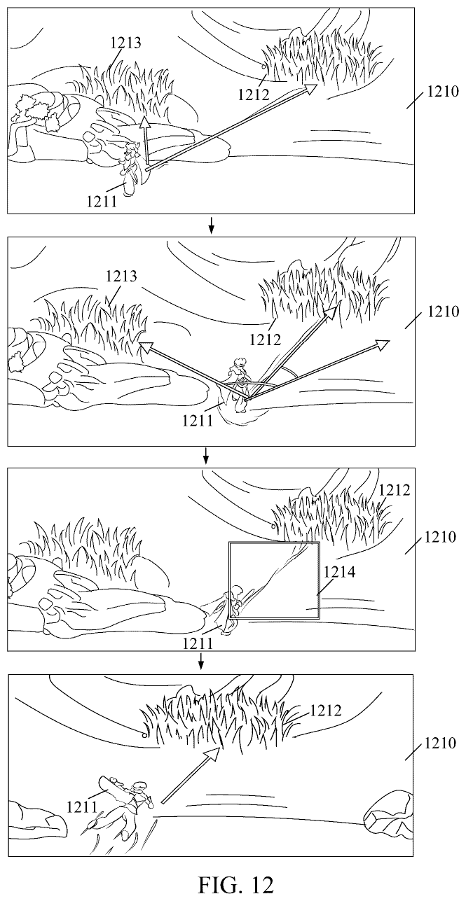

FIG. 12 is a schematic diagram of an interface of a virtual object control method according to an exemplary embodiment of this application. A first virtual object 1211 is displayed in a display interface 1210. The first virtual object 1211 has a first skill. At least one candidate virtual object includes a first virtual grass 1212 and a second virtual grass 1213. The first player who controls the first virtual object 1211 adjusts the facing direction of the first virtual object 1211 from facing the second virtual grass 1213 to facing the first virtual grass 1212 through a turning operation on the first virtual object 1211. Subsequently, according to the first position and the facing direction of the first virtual object 1211, the first virtual grass 1212 is determined as the second virtual object. For the determination manner of the second virtual object, reference may be made to the foregoing content, and details are not repeated here. When the first virtual grass 1212 is located in the skill cast range of the first skill, a linear skill indicator 1214 of the first skill is displayed between the first virtual object 1211 and the first virtual grass 1212, and the display type of the linear skill indicator 1214 is a plurality of curves. In response to the skill cast operation, the first virtual object 1211 is controlled to cast the first skill to the first virtual grass 1212. The arrows shown in FIG. 12 are all used to assist understanding and are not displayed on the display interface 1210.

In conclusion, in the virtual object control method provided in the embodiments of this application, two methods for determining the second virtual object are given: When the second virtual object is determined through the position angle, the target virtual object corresponding to the position angle meeting the first condition is determined as the second virtual object; and when the second virtual object is determined by the relative distance, the target virtual object corresponding to the relative distance meeting the second condition is determined as the second virtual object.

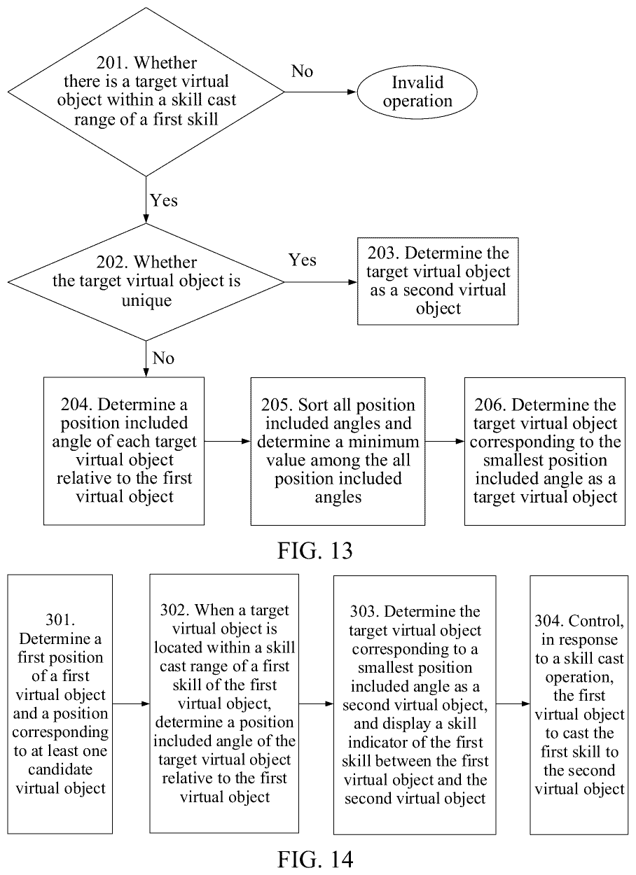

FIG. 13 is a flowchart of determining a second virtual object according to an exemplary embodiment of this application. The method is applied to a terminal and includes the following steps:

Step 201: Determine whether there is a target virtual object in a skill cast range of a first skill.

For example, the first skill is cast by the first virtual object, and the target virtual object is one of at least one candidate virtual object. For the relevant description of the first skill, the skill cast range, and the target virtual object, refer to the foregoing content, and details will not be repeated here.

When there is a target virtual object in the skill cast range of the first skill, step 202 is executed; and when there is no target virtual object in the skill cast range of the first skill, the skill cast operation is determined as an invalid operation, that is, the first virtual object is controlled not to cast the first skill.

Step 202: Determine whether the target virtual object is unique.

When the target virtual object is unique, step 203 is executed; and when the target virtual object is not unique, step 204 is executed.

Step 203: Determine the target virtual object as a second virtual object.

Step 204: Determine a position angle of each target virtual object relative to the first virtual object.

For the relevant description of the position angle, refer to the foregoing content, and details will not be repeated here. When the target virtual object is not unique, a plurality of position angles may be obtained according to the relative positions of the first virtual object and each target virtual object.

Step 205: Sort all position angles and determine a minimum value among the all position angles.

According to step 204, the position angle corresponding to each target virtual object may be obtained. Subsequently, the obtained plurality of position angles are sorted by size to determine a minimum value among all position angles.

Step 206: Determine the target virtual object corresponding to the smallest position angle as the second virtual object.

According to step 205, by sorting all position angles, the minimum value of all position angles may be determined. Subsequently, the target virtual object corresponding to the smallest position angle is determined as the second virtual object.

FIG. 14 is a flowchart of a virtual object control method according to an exemplary embodiment of this application. The method includes the following steps.

Step 301: Determine a first position of a first virtual object and a position corresponding to at least one candidate virtual object.

For example, the first virtual object has a first skill. For the relevant description of the first virtual object and the candidate virtual object, refer to the foregoing content.

Step 302: When the target virtual object is located in the skill cast range of the first skill of the first virtual object, determine a position angle of the target virtual object relative to the first virtual object.

For the relevant description of the target virtual object, the skill cast range, and the position angle, refer to the foregoing content.

Step 303: Determine the target virtual object corresponding to a smallest position angle as a second virtual object, and display a linear skill indicator of the first skill between the first virtual object and the second virtual object.

For example, the second virtual object is determined based on the facing direction of the first virtual object, and in the embodiment of this application, the second virtual object is determined through the position angle. For the relevant description of the position angle and the linear skill indicator, refer to the foregoing content.

Step 304: Control, in response to a skill cast operation, the first virtual object to cast the first skill to the second virtual object.

For the relevant description of the skill cast operation, refer to the foregoing content.

In conclusion, in the virtual object control method provided in the embodiments of this application, before the first skill is cast, the second virtual object is determined based on the facing direction of the first virtual object, and the linear skill indicator of the first skill is automatically displayed between the first virtual object and the second virtual object, so that a player who controls the first virtual object can change the second virtual object by adjusting the facing direction of the first virtual object and a target object of the first skill is allowed to quickly lock and aim before the skill cast operation, thereby improving accuracy of casting the first skill.

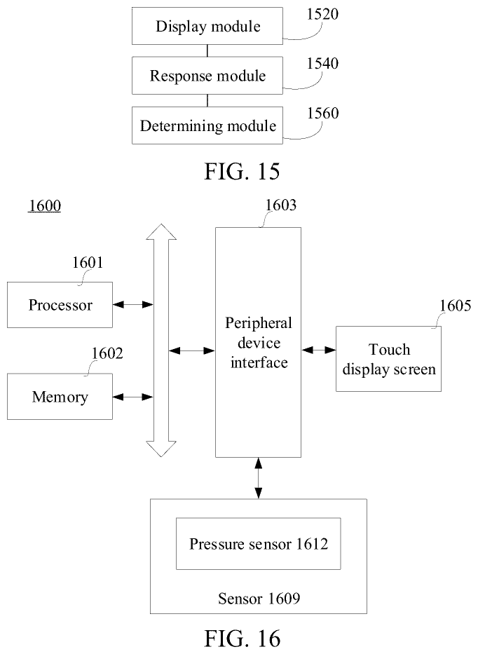

FIG. 15 is a structural diagram of a virtual object control apparatus according to an exemplary embodiment of this application. The apparatus includes:
a display module 1520, configured to display a first virtual object and at least one candidate virtual object, the first virtual object having a first skill;
the display module 1520 being further configured to display, when a second virtual object is located within a skill cast range of the first skill, a linear skill indicator of the first skill between the first virtual object and the second virtual object, the second virtual object being one of the at least one candidate virtual object, the second virtual object being determined based on a facing direction of the first virtual object, a first end of the linear skill indicator being located on the first virtual object, and a second end of the linear skill indicator being located on the second virtual object;
the display module 1520 being further configured to update, when at least one of the first virtual object and the second virtual object moves, display of the linear skill indicator; and
a response module 1540, configured to control, in response to a skill cast operation, the first virtual object to cast the first skill to the second virtual object.

In some embodiments, the display module 1520 is further configured to update, when at least one of the first virtual object and the second virtual object moves, at least one of display of a display length and a display position of the linear skill indicator.

In some embodiments, the display module 1520 is configured to update the display of the display length of the linear skill indicator according to the line distance between the first virtual object and the second virtual object.

In some embodiments, the display module 1520 is configured to shorten, when the first virtual object or the second virtual object is approaching each other, the display length of the linear skill indicator; or increase, when the first virtual object or the second virtual object moves away from each other, the display length of the linear skill indicator.

In some embodiments, the display module 1520 is configured to update the display of the display position of the linear skill indicator according to the inclination angle of the second virtual object relative to the facing direction of the first virtual object.

In some embodiments, the display module 1520 is configured to increase, when the inclination angle becomes larger, the inclination angle of the display position of the linear skill indicator relative to the facing direction of the first virtual object; or decrease, when the inclination angle becomes smaller, the inclination angle of the display position of the linear skill indicator relative to the facing direction of the first virtual object.

In some embodiments, the display module 1520 is further configured to cancel, when a change magnitude of the facing direction of the first virtual object is greater than a change condition, the display of the linear skill indicator; or cancel, when the second virtual object is beyond the skill cast range of the first skill, the display of the linear skill indicator.

In some embodiments, the display module 1520 is further configured to cancel, when the facing direction of the first virtual object is changed from facing the second virtual object to facing a third virtual object, the display of the linear skill indicator between the first virtual object and the second virtual object, and display the linear skill indicator between the first virtual object and the third virtual object, where the third virtual object is another object of the at least one candidate virtual object, and the third virtual object is located within the skill cast range of the first skill.

In some embodiments, the response module 1540 is configured to display, in response to a touch down operation on a skill control corresponding to the first skill, the linear skill indicator of the first skill between the first virtual object and the second virtual object; and control, in response to a termination of the touch down operation on the skill control, the first virtual object to cast the first skill to the second virtual object.

In some embodiments, the linear skill indicator is a spatial linear skill indicator; and the display module 1520 is configured to display the spatial linear skill indicator of the first skill between the first virtual object and the second virtual object, where a display position of the spatial linear skill indicator is higher than a virtual ground of a virtual environment.

In some embodiments, the apparatus further includes a determining module 1560, configured to determine, according to a first position and the facing direction of the first virtual object, the second virtual object from the at least one candidate virtual object.

In some embodiments, the determining unit 1560 is configured to determine a position angle of a target virtual object of the at least one candidate virtual object relative to the first virtual object; and determine, when the position angle meets a first condition, the target virtual object as the second virtual object.

In some embodiments, the determining module 1560 is configured to determine an angle formed by a first ray and a second ray as the position angle, where the first ray is determined according to the first position and the facing direction, and the second ray is determined based on the first position and a second position of the target virtual object.

In some embodiments, the first condition includes at least one of the following conditions: a value of the position angle is a smallest value of position angles corresponding to at least two target virtual objects; and a value of the position angle is less than a first preset value.

In some embodiments, the determining unit 1560 is configured to determine a relative distance between a target virtual object of the at least one candidate virtual object and the first virtual object; and determine, when the relative distance meets a second condition, the target virtual object as the second virtual object.

In some embodiments, the determining module 1560 is configured to determine a first ray according to the first position and the facing direction; and determine a vertical distance from a second position of the target virtual object to the first ray as the relative distance.

In some embodiments, the second condition includes at least one of the following conditions: a value of the relative distance is a smallest value of vertical distances corresponding to at least two target virtual objects; and a value of the relative distance is less than a second preset value.

In some embodiments, the determining module 1560 is further configured to obtain a distance between the first virtual object and each candidate virtual object; and determine, based on the distance between the first virtual object and the candidate virtual object, the candidate virtual object in the skill cast range as the target virtual object.

In some embodiments, the display module 1520 is configured to display a prompt effect on the second virtual object in response to the skill cast operation, where the prompt effect is used to indicate that the target object of the first skill is the second virtual object; and control the first virtual object to cast the first skill to the second virtual object.

In some embodiments, the response module 1540 is further configured to adjust, in response to the turning operation on the first virtual object, the facing direction of the first virtual object.

In some embodiments, the second virtual object includes at one of the following virtual objects: a virtual object with a health value; and a virtual object without a health value and not belonging to a same camp.

FIG. 16 is a structural block diagram of a terminal 1600 according to an exemplary embodiment of this application. The terminal 1600 may be: a smartphone, a tablet computer, an MP3 player, an MP4 player, a notebook computer, or a desktop computer. The terminal 1600 may be further referred to as user equipment.

Generally, the terminal 1600 includes: a processor 1601 and a memory 1602.

The processor 1601 may include one or more processing cores, such as a 4-core processor or an 8-core processor. The processor 1601 may be implemented by at least one hardware form in a digital signal processing (DSP), a field-programmable gate array (FPGA), and a programmable logic array (PLA). The processor 1601 may also include a main processor and a co-processor. The main processor is a processor for processing data in a wake-up state, also referred to as a central processing unit (CPU). The coprocessor is a low-power consumption processor configured to process data in a standby state. In some embodiments, the processor 1601 may be integrated with a graphics processing unit (GPU). The GPU is configured to be responsible for rendering and drawing content that a display needs to display. In some embodiments, the processor 1601 may further include an artificial intelligence (AI) processor. The AI processor is configured to process a computing operation related to machine learning.

The memory 1602 may include one or more computer-readable storage media. The computer-readable storage media may be non-transitory. The memory 1602 may also include a high-speed random access memory, as well as non-volatile memory, such as one or more disk storage devices and flash storage devices. In some embodiments, the non-transient computer-readable storage medium in the memory 1602 is configured to store at least one instruction. The at least one instruction is executed by the processor 1601 to perform the virtual object control method provided in the method embodiment in this application.

In some embodiments, the terminal 1600 may include: a peripheral device interface 1603 and at least one peripheral device. The processor 1601, the memory 1602, and the peripheral interface 1603 may be connected through a bus or a signal cable. Each peripheral may be connected to the peripheral interface 1603 through a bus, a signal cable, or a circuit board. Specifically, the peripheral device includes: a touch display screen 1605.

The touch display screen 1605 is configured to display a user interface (UI). The UI may include a graph, a text, an icon, a video, and any combination thereof. The touch display screen 1605 also has a capability of collecting a touch signal on or above a surface of the touch display screen 1605. The touch signal may be inputted, as a control signal, to the processor 1601 for processing. In this case, the touch display screen 1605 may be further configured to provide a virtual button and/or a virtual keyboard, which is also referred to as a soft button and/or a soft keyboard. In some embodiments, there may be one touch display screen 1605, disposed on a front panel of the terminal 1600. In some other embodiments, there may be at least two touch display screens 1605, disposed on different surfaces of the terminal 1600 respectively or in a folded design. In still other embodiments, the touch display screen 1605 may be a flexible display screen, disposed on a curved surface or a folded surface of the terminal 1600. Even, the touch display screen 1605 may be further set in a non-rectangular irregular pattern, namely, a special-shaped screen. The touch display screen 1605 may be prepared by using materials such as a liquid crystal display (LCD), an organic light-emitting diode (OLED), or the like.

In some embodiments, the terminal 1600 further includes one or more sensors 1609. The one or more sensors 1609 include but are not limited to a pressure sensor 1612.

The pressure sensor 1612 may be disposed on a side frame of the terminal 1600 and/or a lower layer of the display screen 1605. When the pressure sensor 1612 is arranged on the side frame of the terminal 1600, a grip signal of the user to the terminal 1600 may be detected, and the processor 1601 performs left and right hand recognition or a quick operation according to the grip signal collected by the pressure sensor 1612. When the pressure sensor 1612 is disposed on the low layer of the touch display screen 1605, the processor 1601 controls, according to a pressure operation of the user on the touch display screen 1605, an operable control on the UI. The operable control includes at least one of a button control, a scroll-bar control, an icon control, and a menu control.

A person skilled in the art can understand that the structure shown in FIG. 16 does not constitute a limitation to the terminal 1600, and the terminal may include more or fewer components than those shown in the figure, or some components may be combined, or a different component arrangement may be used.

An embodiment of this application further provides a computer device. The computer device includes a processor; and the processor being configured to: display a first virtual object and at least one candidate virtual object, the first virtual object having a first skill; display, when a second virtual object is located within a skill cast range of the first skill, a linear skill indicator of the first skill between the first virtual object and the second virtual object, the second virtual object being one of the at least one candidate virtual object, the second virtual object being determined based on a facing direction of the first virtual object, a first end of the linear skill indicator being located on the first virtual object, and a second end of the linear skill indicator being located on the second virtual object; update, when at least one of the first virtual object and the second virtual object moves, at least one of display of a display length and a display position of the linear skill indicator; control, in response to a skill cast operation, the first virtual object to cast the first skill to the second virtual object.

This application further provides a computer-readable storage medium, storing a computer program, and the computer program being executed by a processor to implement the foregoing virtual object control method.

This application further provides a chip, including a programmable logic circuit and/or program instructions, and when the chip runs, the chip being configured to perform the foregoing virtual object control method.

This application further provides a computer program product or a computer program, including computer instructions, the computer instructions being stored in a computer-readable storage medium, a processor reading the computer instructions from the computer-readable storage medium, and executing the computer instructions, to implement the foregoing virtual object control method.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit

What is claimed is:

1. A virtual object control method, performed by a computer device, the method comprising:
displaying a first virtual object and a second virtual object, the first virtual object having a first skill;
selecting the second virtual object located within a skill cast range of the first skill based on a preset rule associated with the first virtual object;
displaying a skill indicator of the first skill between the first virtual object and the second virtual object;
when at least one of the first virtual object and the second virtual object moves, updating the display of the skill indicator; and
in response to a skill cast operation, controlling the first virtual object to cast the first skill to the second virtual object.

2. The method according to claim 1, wherein the preset rule associated with the first virtual object is based on a facing direction of the first virtual object.

3. The method according to claim 2, wherein the method further comprises:
when the facing direction of the first virtual object is changed from facing the second virtual object to facing a third virtual object located within the skill cast range of the first skill:
canceling the display of the skill indicator between the first virtual object and the second virtual object; and
displaying the skill indicator between the first virtual object and the third virtual object.

4. The method according to claim 1, wherein the method further comprises:
when a change magnitude of the facing direction of the first virtual object is greater than a change condition, canceling the display of the skill indicator; or
when the second virtual object is beyond the skill cast range of the first skill, canceling the display of the skill indicator.

5. The method according to claim 1, wherein the updating the display of the skill indicator further comprises:
moving an end of the skill indicator according to a movement of a corresponding one of the first virtual object and the second virtual object.

6. The method according to claim 1, wherein the skill cast range of the first skill is dependent on a skill level of a player associated with the first virtual object.

7. The method according to claim 1, wherein the skill cast operation is triggered by pressing a skill button associated with the first skill.

8. The method according to the claim 1, wherein the displaying a skill indicator of the first skill between the first virtual object and the second virtual object comprises:
in response to a touch down operation on a skill control corresponding to the first skill, displaying the skill indicator of the first skill between the first virtual object and the second virtual object; and
the controlling the first virtual object to cast the first skill to the second virtual object comprises:
in response to a termination of the touch down operation on the skill control, controlling the first virtual object to cast the first skill to the second virtual object.

9. The method according to the claim 1, wherein the skill indicator is a spatial skill indicator; and
the displaying a skill indicator of the first skill between the first virtual object and the second virtual object comprises:
displaying the spatial skill indicator of the first skill between the first virtual object and the second virtual object above a virtual ground of a virtual environment including the first virtual object and the second virtual object.

10. The method according to claim 1, wherein the method further comprises:
determining, according to a first position and the facing direction of the first virtual object, the second virtual object from a plurality of candidate virtual objects.

11. The method according to claim 11, wherein the determining, according to a first position and the facing direction of the first virtual object, the second virtual object from a plurality of candidate virtual objects comprises:
determining a position angle of a target virtual object of the plurality of candidate virtual objects relative to the first virtual object; and
determining, when the position angle meets a first condition, the target virtual object as the second virtual object.

12. The method according to claim 11, wherein the determining, according to a first position and the facing direction of the first virtual object, the second virtual object from a plurality of candidate virtual objects comprises:
determining a relative distance between a target virtual object of the plurality of candidate virtual objects and the first virtual object; and
determining, when the relative distance meets a second condition, the target virtual object as the second virtual object.

13. A computer device, comprising a processor and memory that stores a plurality of instructions, wherein the plurality of instructions, when executed by the processor, cause the computer device to perform a virtual object control method including:
displaying a first virtual object and a second virtual object, the first virtual object having a first skill;
selecting the second virtual object located within a skill cast range of the first skill based on a preset rule associated with the first virtual object;
displaying a skill indicator of the first skill between the first virtual object and the second virtual object;
when at least one of the first virtual object and the second virtual object moves, updating the display of the skill indicator; and
in response to a skill cast operation, controlling the first virtual object to cast the first skill to the second virtual object.

14. The computer device according to claim 14, wherein the preset rule associated with the first virtual object is based on a facing direction of the first virtual object.

15. The computer device according to claim 15, wherein the method further comprises:
when the facing direction of the first virtual object is changed from facing the second virtual object to facing a third virtual object located within the skill cast range of the first skill:
canceling the display of the skill indicator between the first virtual object and the second virtual object; and
displaying the skill indicator between the first virtual object and the third virtual object.

16. The computer device according to claim 14, wherein the method further comprises:
when a change magnitude of the facing direction of the first virtual object is greater than a change condition, canceling the display of the skill indicator; or
when the second virtual object is beyond the skill cast range of the first skill, canceling the display of the skill indicator.

17. The computer device according to claim 14, wherein the updating the display of the skill indicator further comprises:
moving an end of the skill indicator according to a movement of a corresponding one of the first virtual object and the second virtual object.

18. The computer device according to claim 14, wherein the skill cast range of the first skill is dependent on a skill level of a player associated with the first virtual object.

19. The computer device according to claim 14, wherein the skill cast operation is triggered by pressing a skill button associated with the first skill.

20. A non-transitory computer-readable storage medium, storing a plurality of instructions, wherein the plurality of instructions, when executed by a processor of a computer device, cause the computer device to perform a virtual object control method including:
displaying a first virtual object and a second virtual object, the first virtual object having a first skill;
selecting the second virtual object located within a skill cast range of the first skill based on a preset rule associated with the first virtual object;
displaying a skill indicator of the first skill between the first virtual object and the second virtual object;
when at least one of the first virtual object and the second virtual object moves, updating the display of the skill indicator; and
in response to a skill cast operation, controlling the first virtual object to cast the first skill to the second virtual object.
